(19) United States
(12) Patent Application Publication
(10) Pub. No.: US 2022/0072677 A1
(43) Pub. Date: Mar. 10, 2022

(54) HAND-GUIDED BATTERY-OPERATED ELECTRIC POWER TOOL

(71) Applicant: Guido VALENTINI, Milano (IT)

(72) Inventor: Guido VALENTINI, Milano (IT)

(21) Appl. No.: 17/464,967

(22) Filed: Sep. 2, 2021

(30) Foreign Application Priority Data
Sep. 10, 2020 (EP) 20 195 451.8

(51) Int. Cl. B24B 23/02; B25F 5/02

(52) U.S. Cl. CPC B24B 23/02; B25F 5/02

(57) ABSTRACT

The invention refers to a hand-guided battery-operated electric power tool (2) comprising a tool housing (4) with a longitudinal extension along a longitudinal axis (36) of the power tool (2), an electric motor (38) and at least one battery (40) for operating the electric motor (38). The electric motor (38) and the at least one battery (40) are received in the tool housing (4). A working element (20) protrudes from a front part (4.1) of the tool housing (4) and is rotatable about an axis of rotation (22). The axis of rotation (22) of the working element (20) extends at an angle of >0° and <180° in respect to the longitudinal axis (36) of the power tool (2). The tool housing (4) comprises along its longitudinal extension the front part (4.1) into which the axis of rotation (22) of the working element (20) extends, a rear part (4.3) opposite to the front part (4.1), and a centre part (4.2) between the front part (4.1) and the rear part (4.3). It is suggested that the electric motor (38) is located in the front part (4.1) of the tool housing (4) and the at least one battery (40) is located in the centre part (4.2) of the tool housing (4).

### BACKGROUND OF THE INVENTION

### 1. Field of Invention

The present invention refers to a hand-guided battery-operated electric power tool. The power tool comprises a tool housing, preferably made of a plastic material, with a longitudinal extension along a longitudinal axis of the power tool. Further, the power tool comprises an electric motor and at least one battery for operating the electric motor. The electric motor and the at least one battery are received in the tool housing. Furthermore, the power tool comprises a working element protruding from a front part of the tool housing and rotatable about an axis of rotation. The axis of rotation of the working element extends at an angle of >0° and <180° in respect to the longitudinal axis of the power tool. Along its longitudinal extension the tool housing comprises the front part with the working element protruding therefrom, a rear part opposite to the front part, and a centre part between the front part and the rear part.

### 2. Description of Related Art

Power tools of the above-mentioned kind are well-known in the prior art. Generally, there are two known main types of these power tools. A first type has a pistol-shaped tool housing and is usually embodied as a power screw driver or a power drill. The working element may be designed as a drill or bit chuck adapted for receiving and releasably fasting thereto a drill or a screw bit. Usually, a transmission mechanism is provided between a motor shaft of the electric motor and the working element. The transmission mechanism may comprise a gear mechanism (transmission ratio 1, <1 (speed increase) or >1 (speed reduction)) and/or a torque clutch. During intended use of the first type of power tool, the longitudinal extension of the tool housing extends in an essentially vertical direction. The front (or top) part of the tool housing has an angular design or extends in an angular manner in respect to the rest of the tool housing. In the first type of power tool, the axis of rotation of the working element extends at an angle in the range of approximately 90° and 120° in respect to the longitudinal axis of the power tool. The battery is usually inserted into or attached to the rear (or bottom) part of the tool housing.

A second known type of power tool has an essentially longitudinal extension merely along a longitudinal axis of the power tool is usually embodied as a polisher, sander or grinder. The working element may be designed as a backing pad, wherein a bottom surface of the backing pad is adapted for releasable attachment of a polishing or sanding member, preferably by means of a hook-and-loop fastener, or it may be designed as a retaining element for attachment of a grinding disc, preferably by means of a screwed connection. A transmission mechanism may be provided between a motor shaft of the electric motor and the working element. The transmission mechanism may comprise at least one gear mechanism (transmission ratio 1, <1 (speed increase) or >1 (speed reduction)), e.g. a bevel gear, and/or a torque clutch. During intended use of the second type of power tool, the longitudinal extension of the tool housing extends in an essentially horizontal direction. The front part of the tool housing has a straight design or extends in a longitudinal manner in respect to the rest of the tool housing. In the second type of power tool, the axis of rotation of the working element extends at an angle in the range of approximately 90° and 120° in respect to the longitudinal axis of the power tool. The battery is usually inserted into or attached to the rear part of the tool housing.

Generally, it is desired to provide for hand-guided battery-powered electric tools that have an increasingly long battery life between consecutive charging cycles and which are capable of delivering high power for maximum performance. However, this trend leads to increasingly large and heavy batteries. On the other hand, the other components of the known power tools, e.g. electric motor, transmission mechanism, electric control units, which are usually located in the other front or centre parts of the tool housing, are designed increasingly smaller and lighter, due to the use of, for example, semiconductor technology, higher electric efficiency of the electronic components and new light-weight and at the same time high-tensile materials. With the known power tools this has the disadvantage that due to the battery being mounted at the rear part of the tool housing, the power tools have a significant overweight at their rear end, which is particularly annoying with the second type of power tools. The user of those power tools has to compensate for the large weight at the rear end of the power tool and at the same time has to provide for additional force at the front end of the power tool in order to press the working element onto the surface of the work piece to be worked. If such an unbalanced power tool is used over a longer period of time, this will lead to fast and significant fatigue of the user. In general, it can be said that the location of the at least one battery at the rear part of the tool housing implies considerable restrictions to the known power tools in terms of design and handling.

### SUMMARY OF THE INVENTION

Therefore, it is an object of the present invention to provide for a hand-guided batter-operated power tool which overcomes the above disadvantages and restrictions. In particular, it is an object to provide for a highly balanced power tool which allows continuous use over a longer period of time without significant fatigue of the user.

In order to solve this object, in particular, starting from a hand-guided battery-operated power tool of the above-mentioned kind, it is suggested that the electric motor is located in the front part of the tool housing and the at least one battery is located in the centre part of the tool housing.

Moving the at least one battery away from the rear part of the power tools opens a whole new variety of design options. In particular, with one of the heaviest components of the power tool, i.e. the at least one battery, being located in the centre part of the tool housing, the power tool can be easily and efficiently balanced in order to allow a continuous use of the power tool over a longer period of time without significant fatigue of the user.

The centre part of the tool housing is that part which is located between the front part, where the electric motor is located, and the rear part. The rear part may comprise an attachment for a cable to a mains power supply. In that case, the power tool can be selectively operated by means of electric energy from the at least one battery and/or the mains power supply. Additionally, when operated by means of electric energy from the mains power supply, the at least one battery could be contemporarily charged by means of an internal charging device. Instead of the attachment for a cable, the rear part could also comprise at least one further receptacle, adapted for receiving at least one further battery from the rear, similar to what is known from the conventional power tools. Alternatively, a power supply unit comprising a transformer could be inserted into the at least one further receptacle in the rear part of the tool housing. A power tool with an external power supply which may be inserted into a receptacle of the tool housing instead of the battery is disclosed, for example, in a pending application EP 2 712 713 A1 filed by the same applicant. This application is incorporated herein by reference in its entirety. Therefore, the centre part of the tool housing is considered to comprise that part of the tool housing between the front part and the rear part.

The centre part of the tool housing may be that part of the tool housing where a user during the intended use of the power tool grasps the power tool with his hand. To this end, at least part of the centre part of the tool housing may have a particularly ergonomic form allowing easy grasping and holding of the tool housing by the user's hand. Furthermore, switches or rotary dials for activating and deactivating and/or controlling the speed of the electric motor of the power tool are preferably arranged such that the user's hand when grasping the power tool at the centre part of the tool housing may easily reach the switch and/or rotary dial, in particular with his thumb or a finger. In particular, the centre part of the tool housing is characterized by the fact that the at least one battery, if extractable from the tool housing, cannot be extracted from the power tool towards the front or the rear of the tool housing. Quite to the contrary, the at least one battery located in the centre part of the tool housing may only be extracted towards the top or bottom or towards a lateral side of the tool housing. Generally speaking, if the at least one battery is adapted to be extracted from the tool housing, one or more receptacles for releasably receiving the at least one battery, open towards the side (top, bottom, left or right) of the tool housing and not to the front or to the rear.

The power tool according to the invention has the advantage that it is highly balanced. This is due to the fact that one of the heaviest components, if not the heaviest component of the power tool is located exactly where the user will grasp the tool housing during the intended use of the power tool. This makes it much easier to provide for a highly balanced power tool in terms of weight distribution. For example, the weight of the electric motor in the front of the tool housing may be easily compensated by the weight of an electronic control unit and/or an additional battery located at the rear part of the tool housing. Furthermore, even if the power tool according to the present invention had a larger weight in the front part of the tool housing, this would only support the user during the intended use of the power tool, as additional weight is automatically applied to the front part and the working element of the power tool. The result is a power tool which can be continuously used over a longer period of time without significant fatigue of the user.

The at least one battery is preferably rechargeable, even though the use of disposable batteries is not excluded. The at least one battery may be extractable/removable from the tool housing or may be built into the tool housing and fixedly connected to the other electronic components of the power tool, for example by means of plugged or soldered connections. In the case of an integrated battery, the charging of the at least one battery may be effected by means of an internal charging device during operation of the power tool by means of a mains power supply or simply be electrically connecting the power tool to a mains power supply, i.e. outside the intended use of the power tool.

According to a preferred embodiment of the present invention, it is suggested that the tool housing comprises at least one first receptacle in the centre part of the tool housing, wherein the at least one first receptacle is accessible from outside the power tool and is adapted/constructed to receive at least part of the at least one battery. Hence according to this embodiment, the at least one battery is easily extractable from the tool housing, for example for substituting it with a new and/or fully charged battery. This allows an almost continuous use of the power tool by simply replacing one or more empty batteries by one or more fully charged batteries. Charging of the batteries may be effected by means of a separate external charging device connected to a mains power supply. In that case, the power tool would not need any internal charging device and connection to a mains power supply but could be operated exclusively by means of the at least on battery.

According to a further preferred embodiment of the invention, it is suggested that the tool housing comprises at least one cover element for closing the at least one first receptacle in respect to the outside of the power tool after insertion and/or removal of the at least one battery into or from the at least one first receptacle. The cover element may be designed separately from the tool housing or connected thereto in a movable manner, for example pivotable about an axis of rotation. Furthermore, the cover element and/or the tool housing, preferably at a position surrounding an opening into the at least one first receptacle, may comprise closure means for holding the cover element in its closed position. The closure means may be operated mechanically (e.g. a snap lock, a latch lock or a snap-in or latching element) or in any other manner, e.g. magnetically. Preferably, the shape, form and design of the cover element is such that the cover element continues the form and design of the adjacent part of the tool housing, providing a smooth, seamless transition from the cover element to the housing.

Preferably, the at least one first receptacle is adapted to receive the at least one battery in its entirety. Thus, the cover element may close the first receptacle after insertion of the battery and provide for an even and visually appealing tool housing, which is more ergonomic and convenient for a user to grasp. Additionally, the complete closure of the first receptacle has the advantage that dust and humidity surrounding the power tool are kept away from the inside of the tool housing, thereby protecting the electronic and mechanical components located inside the tool housing.

According to yet another preferred embodiment of the invention it is suggested that the at least one battery makes part of a removable battery pack, which is adapted to be at least partially inserted into a first receptacle provided in the centre part of the tool housing. The battery pack may comprise a battery housing, preferably made of plastic material, with the at least one battery located therein. Preferably, the at least one battery is sealed into the battery housing and cannot be extracted therefrom. The battery housing is provided with at least two external contacts allowing charging of the at least one battery located inside the battery housing and the electric connection of the at least one battery to the other electronic components of the power tool. If the battery pack comprises more than one battery, the batteries may be electrically connected to each other inside the battery housing and/or to the external contacts in series and/or in parallel. Preferably, the battery pack has the form of a conventional off-the-shelf battery pack, for example having a rectangular or a triangular housing and providing a voltage of 10.8 V, 12 V, 18 V, 24 V or even more. If the battery pack may be fully inserted into the first receptacle, the battery housing does not have to have a particular design (colour or surface quality), because it is not visible from outside the power tool during the intended use of the tool. The battery pack may even be completely enclosed in the receptacle by means of a cover element, and thus fully obstructed from any external view and protected from external environmental impacts. This significantly reduces the costs of developing and purchasing the battery pack.

The electric motor located in the front part of the tool housing may be oriented in almost any desired direction. In particular, it is suggested that a motor shaft of the electric motor is directly connected in a torque-proof manner to a tool shaft of the power tool or constitutes the tool shaft, wherein the tool shaft is rotatable about the axis of rotation and the working element is directly or indirectly attached to the tool shaft. In this embodiment, the electric motor is oriented perpendicular in respect to the longitudinal extension of the tool housing, i.e. the motor shaft rotates about the axis of rotation of the working element, which extends perpendicular in respect to the longitudinal axis of the power tool, or parallel in respect to the axis of rotation. Of course, it would also be possible to slightly tilt the electric motor resulting in an angle between the longitudinal axis and the axis of rotation of >90°. Attachment of the working element to the tool shaft comprises a torque proof connection between the working element and the tool shaft in the plane of rotation of the working element extending perpendicular (or in an angle >90°) in respect to the axis of rotation and a holding force acting in a direction parallel to the axis of rotation in order to hold the working element connected to the tool shaft. The holding force may be effected mechanically, e.g. by means of a nut, a screw, a snap-in connection or the like, or magnetically, e.g. by means of magnetic elements comprising solenoids, permanent magnets and/or ferromagnetic elements located in respective positions at the tool shaft and the working element. A power tool with a working element attached to a tool shaft and held in respect thereto by means of magnetic holding force is disclosed, for example, in a pending application EP 3 520 962 A1 filed by the same applicant. This application is incorporated herein by reference in its entirety. If the motor shaft of the electric motor constitutes the tool shaft of the power tool a highly integrated particularly compact power tool may be provided.

Alternatively, it is suggested that a motor shaft of the electric motor is indirectly connected to a tool shaft of the power tool by means of a transmission mechanism, wherein the tool shaft is rotatable about the axis of rotation and the working element is directly or indirectly attached to the tool shaft. The motor shaft may extend coaxially or in an angle in respect to the axis of rotation. The transmission mechanism may comprise a gear mechanism (transmission ratio 1, <1 (speed increase) or >1 (speed reduction)) and/or a torque clutch. If the motor shaft extends in an angle in respect to the axis of rotation, the transmission mechanism may comprise a bevel gear. The gear mechanism may be of any known type, for example a planetary gear.

In particular, it is suggested that the transmission mechanism comprises a mechanical gear mechanism or a magnetic gear mechanism. In a mechanical gear mechanism torque is transmitted by means of meshing teeth of gear wheels, whereas in a magnetic gear mechanism torque is transmitted contact-free by means of interacting magnetic fields and forces. Thus, in a magnetic gear mechanism the gear wheels are provided with magnetic elements, in particular permanent magnets, which create magnetic fields for each gear wheel. The magnetic field of a driving gear wheel rotates together with the driving gear wheel and by means of interaction with the magnetic field of a driven gear wheel induces a rotation of the driven gear wheel. A further gear wheel comprising magnetic elements may be located between the driving gear wheel and the driven gear wheel. By rotating the further gear wheel at a given speed the transmission ration of the magnetic gear mechanism can be adjusted. A power tool with a magnetic gear mechanism is known, for example, from pending applications EP 3 501 753 A1; EP 3 501 755 A1 and 3 598 613 A1, all filed by the same applicant. These applications are incorporated herein by reference in their entirety.

According to a further preferred embodiment, it is suggested that the tool housing comprises at least one second receptacle in the rear part of the tool housing, wherein the at least one second receptacle is accessible from outside, preferably from the rear, of the power tool and is adapted to receive at least part of at least one further battery. This embodiment may provide for a particularly powerful power tool or for a power tool having a particularly long period of continuous use between consecutive charging cycles of the at least one battery. Furthermore, the weight of the at least one further battery may be used for further balancing the power tool for further increasing ease of use. With most components of the power tool—except for the battery—located mainly in the front part of the tool housing becoming more and more light-weighted, the at least one further battery may be selected such that it just about compensates the weight of the front part of the housing and the components located therein, irrespective of its electric capacity. To this end, the at least one further battery may even be selected rather light-weighted with only a reduced electric capacity, because the larger amount of electric energy is provided by the at least one first battery located in the centre part of the tool housing. The at least one further battery may serve as a back-up in case the at least one first battery runs out of energy.

The power tool according to the present invention has the above-mentioned advantages in particular when the power tool is designed as a polishing or sanding machine, and the working element is designed as a backing pad, wherein a bottom surface of the backing pad is adapted for releasable attachment of a polishing or sanding member, preferably by means of a hook-and-loop fastener. According to this embodiment, the power tool is of the above-mentioned second type having a rather large longitudinal extension. In this type of power tools, it is particularly important that the power tool is balanced perfectly well. The need for a perfectly balanced power tool is further reinforced by the fact that this type of power tools is generally operated in its intended use over a long period of time, for example for polishing or sanding entire vehicle bodies or boat hulls or aircraft fuselages. The unique design of the hand-guided battery-operated power tool according to the present invention reflects the concentrated approach to ergonomics and results in a very stable tool that is light and manoeuvrable while still delivering all the power necessary to accomplish a world class finish.

### BRIEF DESCRIPTION OF THE DRAWING

Further features and advantages of the present invention will become apparent from the figures and the respective description. In this context it is emphasized that the present invention is not limited to the embodiments shown in the figures. Each of the features shown in one or more of the figures may be essential to the invention, even if not explicitly mentioned in the description. Further, the features shown in one or more of the figures may be combined in any desired manner with each other, even if that combination is not explicitly mentioned in the description. The figures show:

FIG. 1 a first embodiment of a hand-guided battery operated power tool according to the present invention;

FIG. 2 a second embodiment of a hand-guided battery operated power tool according to the present invention; and

FIG. 3 a schematic sectional view of a hand-guided battery operated power tool according to the present invention.

### DETAILED DESCRIPTION OF THE BEST MODE OF THE INVENTION

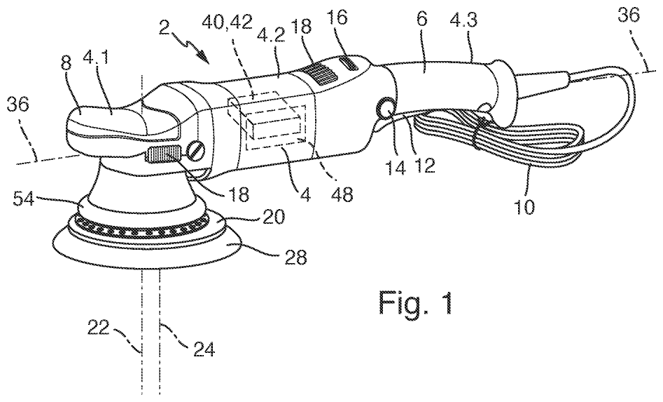

In FIG. 1 an example of a hand-guided electric power tool according to the present invention is designated with reference sign 2 in its entirety. In this embodiment the power tool 2 is embodied as a random orbital polisher. The polisher 2 has a tool housing 4, essentially made of plastic material. The housing 4 has a handle 6 at its rear end and a grip 8 at its front end. The handle 6 or at least a rear end of the handle 6 constitutes a rear part 4.3 of the housing 4. The grip 8 makes part of a front part 4.1 of the housing 4. The part of the housing 4 located between the front part 4.1 and the rear part 4.3 constitutes a centre part 4.2 of the housing 4.

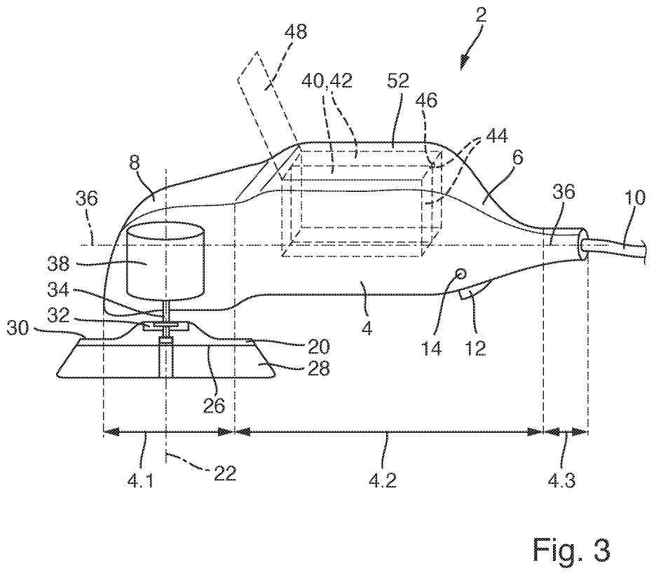

An electric power supply cable 10 with an electric plug at its distal end exits the housing 4 at the rear part 4.3. Thus, besides a battery-operation of the power tool 2, it can also be operated by means of electric energy from a mains power supply. Of course, the electric cable 10 could also be omitted resulting in a power tool 2 which is exclusively battery operated. At the bottom side of the handle 6 a switch 12 is provided for turning on and off an electric motor 38 (see FIG. 3) of the power tool 2. The switch 12 can be continuously held in its activated position by means of a push button 14. The power tool 2 can be provided with speed adjustment means 16 (e.g. a knurled wheel) for adjusting the rotational speed of the electric motor 38. The housing 4 can be provided with cooling openings 18 for allowing heat from electronic components and/or the electric motor 38 both located inside the housing 4 to dissipate into the environment and/or for letting a cooling air stream from the environment enter into the inside of the housing 4.

A working element 20 protrudes from the front part 4.1 of the tool housing 4. The working element 20 is rotatable about an axis of rotation 22. Additionally, and superimposing the forced rotation about the axis 22, the working element is also freely rotatable about a second axis of rotation 24, extending parallel to and spaced apart from the axis 22. The superimposition of the forced rotational movement about the axis 22 and the free rotational movement about the axis 24 leads to the desired random orbital working movement of the working element 20. The random orbital movement is realized by means of a transmission mechanism functionally located between a motor shaft of the electric motor 38 and the tool shaft 34, the transmission mechanism comprising an eccentric element (not shown), which is attached to a tool shaft 34 of the power tool 2 in a torque proof manner and to which the working element 20 is attached in a freely rotatable manner.

Alternatively, instead of the eccentric element, the transmission mechanism could comprise a gear mechanism, e.g. in the form of a planetary gear mechanism, resulting in a gear-driven forced orbital movement of the working element 20. In yet another possibility, the working element 20 could be directly attached to the tool shaft 34 of the power tool 2 resulting in a purely rotational working movement.

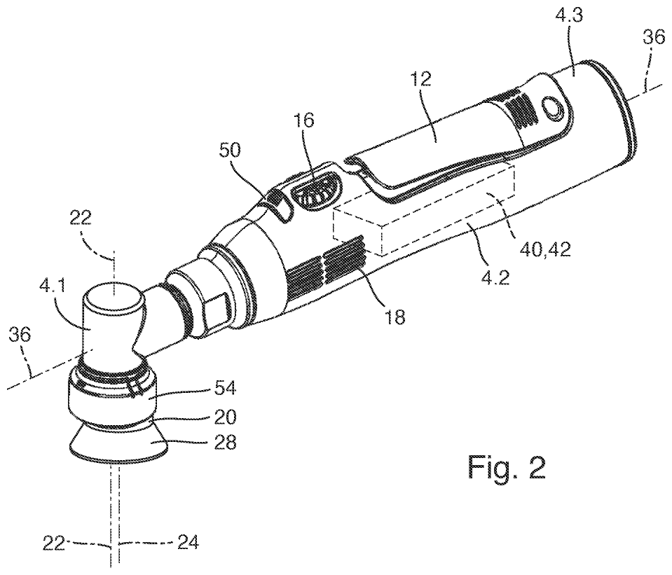

In FIGS. 1 and 2, the transmission mechanism is covered by a protective shroud 54 which is attached to the bottom of the front part 4.1 of the tool housing 4, and therefore it is not visible in the Figs. The transmission mechanism is functionally located between the motor shaft of the electric motor 38 and the tool shaft 34 of the power tool 2. It would even be possible to integrate the transmission mechanism into the electric motor 38, in which case the tool shaft 34 would be protruding from the combined electric motor-transmission mechanism unit.

In this embodiment, the working element 20 has the form of a plate-like backing pad. The backing pad 20 has a bottom surface 26 for releasable attachment of a polishing or abrasive member 28 (e.g. by means of hook-and-loop fastener) and an opposite top surface 30 with a backing pad-connection arrangement 32 for releasable attachment of the backing pad 20 to the tool shaft 34 of the power tool 2. The backing pad-connection arrangement 32 may comprise a metal insert which is moulded into the material of the backing pad 20 and/or its top surface 30 during manufacture of the backing pad 20 by means of a moulding, co-moulding or an injection moulding process.

Even though, in the embodiment of FIG. 1 the power tool 2 is embodied as a random orbital polisher, the power tool 2 could just as well be embodied as any other type of power tool having a working element 20 rotatable about an axis of rotation 22, in particular as a sander or a grinder. Furthermore, the power tool 2 could also perform any kind of other working movement, for example a purely rotary movement (see FIG. 3), an eccentric movement or a gear-driven (forced) orbital movement.

In the embodiment of FIG. 2, the power tool 2 is also a random-orbital polisher which is operated exclusively by electric energy from at least one battery. Besides the features already mentioned in respect to the embodiment of FIG. 1, the embodiment of FIG. 2 additionally has indicator lights 50, possibly in different colours (e.g. green, yellow, red) for indicating the current charging status of the at least one battery for operating the power tool 2 and/or for indicating the current speed of the electric motor 38 and/or the working element 20. In FIG. 2, the switch 12 is designed as a spring-loaded lever which may be pressed downwards by the palm of a user's hand, thereby activating the electric motor 38.

The tool housing 4 has a longitudinal extension along a longitudinal axis 36 of the power tool 2. The electric motor 38 is located in the front part 4.1 of the tool housing 4. At least one battery 40 is located or received in the centre part 4.2 of the housing 4. The axis of rotation 22 of the working element 20 extends at an angle in the range of larger than 0° and smaller than 180° in respect to the longitudinal axis 36 of the power tool 2. According to a preferred embodiment, the angle is in the range of 45° to 135°, particularly preferred in the range of 70° to 110°. In the embodiments of FIGS. 1 and 3 the angle is approximately 90°, in the embodiment of FIG. 2 the angle is slightly larger and about 100°.

Preferably, the at least one battery 40 makes part of a battery pack 42 which is inserted in a receptacle 44 of the tool housing 4 through an opening. In FIG. 1 the opening is on the left side of the housing 4 facing towards an observer. In FIG. 2 the opening may be on the bottom side of the tool housing 4. In FIG. 3 the opening is on the top side of the housing 4. The battery pack 42 may be fastened inside the receptacle 44 by means of fastening means 46 which may be operated mechanically (e.g. a snap lock, a latch lock or a snap-in or latching element) or in any other manner, e.g. magnetically. By inserting the battery pack 42 inside the receptacle 44 the at least one battery 40 is automatically set into electric contact with the other electronic components of the power tool 2, e.g. an electronic control unit (ECU), the electric motor 38, the switch 12, the speed adjustment means 16 etc. The opening of the receptacle 44 in the housing 4 may be covered and closed by means of a cover element 48, e.g. in the form of a lid or a cover. The cover element 48 may fasten the battery pack 42 inside the receptacle 44.

The cover element 48 may be held in its closed position by appropriate securing means. These may be the same as the fastening means 46 for fastening the battery pack 42 in the receptacle 44 or they are separate means 48. The securing means may be operated mechanically (e.g. a snap lock, a latch lock or a snap-in or latching element) or in any other manner, e.g. magnetically. In the embodiment of FIG. 3 the securing means are identical to the fastening means 46.

The cover element 48 may protect the battery pack 42 and other components of the power tool 2 inside the tool housing 4 from humidity, dust and dirt. To this end, a sealing element 52, e.g. a sealing lip, may be provided around the opening of the at least one receptacle 44 for interaction with the closed cover element 48.

In the embodiments of FIGS. 1 to 3, the battery pack 42 is extractable from the tool housing 4. In contrast thereto, it would also be possible that the battery pack 42 is fixed in the inside of the housing 4 and fixedly connected to the other electronic components of the power tool 2. In that case there would not have to be a receptacle 44 in the tool housing 4 opening towards the environment and no cover element 48. Replacement of the battery pack 42 could be performed by specialized skilled workers only. They would have to disassemble the housing 4, separate the battery pack 42 from the rest of the electronic components of the power tool 2, for example by soldering or by releasing a plug connection accessible only form the inside of the tool housing 4. Then a new battery pack 42 would have to be inserted into the tool housing 4, fastened therein and brought into electric connection with the other electrical components of the power tool 2. Finally, the tool housing 4 would have to be reassembled. Replacement of the battery pack 42 would be performed only if the at least one battery 40 was defective. Charging of the at least one battery 40 would be effected by means of an internal charger making part of the power tool 2. Despite the obvious drawbacks in respect to replacement of the at least one battery 40, such a power tool 2 still has the advantage of being particularly well balanced in terms of weight distribution along the longitudinal axis 36 of the power tool 2 and particular ease of use of the power tool 2.

In the embodiment of FIG. 3, a motor shaft of the electric motor 38 is directly connected in a torque-proof manner to the tool shaft 34 of the power tool 2 or constitutes the tool shaft 34, the tool shaft 34 being rotatable about the axis of rotation 22 and the working element 20 being directly or indirectly attached to the tool shaft 34.

In the embodiments of FIGS. 1 and 2, the motor shaft of the electric motor 38 is indirectly connected to the tool shaft 34 of the power tool 2 by means of the transmission mechanism, e.g. in the form of an eccentric element and/or a gear mechanism. The tool shaft 34 is rotatable about the axis of rotation 22 and the working element 20 is directly or indirectly attached to the tool shaft 34.

The motor shaft of the electric motor 38 is rotatable about the axis of rotation 22 of the working element 20. In the embodiments of FIGS. 1 and 3, the motor shaft has an essentially vertical orientation, i.e. extending in an angle of approximately 90° in respect to the longitudinal axis 36 of the power tool 2. In the embodiment of FIG. 2, the motor shaft has a slightly slanted orientation in respect to the strictly vertical orientation, i.e. extending in an angle of more than 90°, in particular about 100°, in respect to the longitudinal axis 36 of the power tool 2.

According to a modification of the embodiments shown in the Figs., the tool housing 4 may comprise at least one second receptacle (not shown) in the rear part 4.3 of the tool housing 4. The at least one second receptacle is accessible from outside, preferably from the rear, of the power tool 2 and is adapted to receive at least part of at least one further battery (not shown). The at least one further battery can be inserted into and extracted from the at least one second receptacle from the rear in a direction extending essentially parallel to the longitudinal axis 36 of the power tool 2. The at least one further battery can provide for additional electric power for the electric motor 38 and/or for additional weight in the rear part 4.3 of the tool housing 4 for a better balancing of the power tool 2. In particular, the at least one further battery can compensate for the weight of the components located in or connected to the front part 4.1 of the tool housing 4, i.e. the electric motor 38, transmission means, the working element 20, a polishing or sanding member 28, etc.

Instead of the at least one further battery, it would also be possible to insert a power supply unit comprising a transformer into the at least one second receptacle in the rear part of the tool housing. A power tool with an external power supply unit which may be inserted into a receptacle of the tool housing instead of the battery is disclosed, for example, in a pending application EP 2 712 713 A1 filed by the same applicant. Such a power supply unit inserted into the at least one second receptacle would allow an almost infinite operation of the power tool 2 and could provide more electric power than a battery.

1. A hand-guided battery-operated electric power tool (2) comprising a tool housing (4) with a longitudinal extension along a longitudinal axis (36) of the hand-guided battery-operated electric power tool (2), an electric motor (38) and at least one battery (40) for operating the electric motor (38), wherein the electric motor (38) and the at least one battery (40) are received in the tool housing (4), and a working element (20) protrudes from a front part (4.1) of the tool housing (4) and is rotatable about an axis of rotation (22), wherein the axis of rotation (22) of the working element (20) extends at an angle of >0° and <180° in respect to the longitudinal axis (36) of the hand-guided battery-operated electric power tool (2), and wherein the tool housing (4) comprises along its longitudinal extension the front part (4.1) into which the axis of rotation (22) of the working element (20) extends, a rear part (4.3) opposite to the front part (4.1), and also comprises a centre part (4.2) between the front part (4.1) and the rear part (4.3),
wherein the electric motor (38) is located in the front part (4.1) of the tool housing (4) and the at least one battery (40) is located in the centre part (4.2) of the tool housing (4).

2. The hand-guided battery-operated electric power tool (2) according to claim 1, wherein the tool housing (4) comprises at least one first receptacle (44) in the centre part (4.2) of the tool housing (4), wherein the at least one first receptacle (44) is accessible from outside the hand-guided battery-operated electric power tool (2) and is adapted to receive at least part of the at least one battery (40).

3. The hand-guided battery-operated electric power tool (2) according to claim 2, wherein the tool housing (4) comprises at least one cover element (48) for closing the at least one first receptacle (44) in respect to the outside of the hand-guided battery-operated electric power tool (2) after insertion and/or removal of the at least one battery (40) into or from the at least one first receptacle (44).

4. The hand-guided battery-operated electric power tool (2) according to claim 2, wherein the at least one first receptacle (44) is adapted to receive the at least one battery (40) in its entirety.

5. The hand-guided battery-operated electric power tool (2) according to claim 1, wherein the at least one battery (40) makes part of a removable battery pack (42), which is adapted to be at least partially inserted into a first receptacle (44) provided in the centre part (4.2) of the tool housing (4).

6. The hand-guided battery-operated electric power tool (2) according to claim 1, wherein a motor shaft of the electric motor (38) is directly connected in a torque-proof manner to a tool shaft (34) of the hand-guided battery-operated electric power tool (2) or constitutes the tool shaft (34), wherein the tool shaft (34) is rotatable about the axis of rotation (22) and the working element (20) is directly or indirectly attached to the tool shaft (34).

7. The hand-guided battery-operated electric power tool (2) according to claim 1, wherein a motor shaft of the electric motor (38) is indirectly connected to a tool shaft (34) of the hand-guided battery-operated electric power tool (2) by means of a transmission mechanism, wherein the tool shaft (34) is rotatable about the axis of rotation (22) and the working element (20) is directly or indirectly attached to the tool shaft (34).

8. The hand-guided battery-operated electric power tool (2) according to claim 7, wherein the transmission mechanism comprises an eccentric element and/or a mechanical or a magnetic gear mechanism.

9. The hand-guided battery-operated electric power tool (2) according to claim 1, wherein a motor shaft of the electric motor (38) is rotatable about the axis of rotation (22) of the working element (20).

10. The hand-guided battery-operated electric power tool (2) according to claim 1, wherein the tool housing (4) comprises at least one second receptacle in the rear part (4.3) of the tool housing (4), wherein the at least one second receptacle is accessible from outside, preferably from the rear, of the hand-guided battery-operated electric power tool (2) and is adapted to receive at least part of at least one further battery.

11. The hand-guided battery-operated electric power tool (2) according to claim 1, wherein the hand-guided battery-operated electric power tool (2) is designed as a polishing or sanding machine and the working element (20) is designed as a backing pad, wherein a bottom surface of the backing pad is adapted for releasable attachment of a polishing or sanding member (28), preferably by means of a hook-and-loop fastener.

12. The hand-guided battery-operated electric power tool (2) according to claim 1, wherein the axis of rotation (22) of the working element (20) extends substantially perpendicular to the longitudinal axis (36) of the hand-guided battery-operated electric power tool (2).

13. The hand-guided battery-operated electric power tool (2) according to claim 3, wherein the at least one first receptacle (44) is adapted to receive the at least one battery (40) in its entirety.

14. The hand-guided battery-operated electric power tool (2) according to claim 2, wherein the at least one battery (40) makes part of a removable battery pack (42), which is adapted to be at least partially inserted into a first receptacle (44) provided in the centre part (4.2) of the tool housing (4).

15. The hand-guided battery-operated electric power tool (2) according to claim 2, wherein a motor shaft of the electric motor (38) is directly connected in a torque-proof manner to a tool shaft (34) of the hand-guided battery-operated electric power tool (2) or constitutes the tool shaft (34), wherein the tool shaft (34) is rotatable about the axis of rotation (22) and the working element (20) is directly or indirectly attached to the tool shaft (34).

16. The hand-guided battery-operated electric power tool (2) according to claim 2, wherein a motor shaft of the electric motor (38) is indirectly connected to a tool shaft (34) of the hand-guided battery-operated electric power tool (2) by means of a transmission mechanism, wherein the tool shaft (34) is rotatable about the axis of rotation (22) and the working element (20) is directly or indirectly attached to the tool shaft (34).

17. The hand-guided battery-operated electric power tool (2) according to claim 2, wherein a motor shaft of the electric motor (38) is rotatable about the axis of rotation (22) of the working element (20).

18. The hand-guided battery-operated electric power tool (2) according to claim 2, wherein the tool housing (4) comprises at least one second receptacle in the rear part (4.3) of the tool housing (4), wherein the at least one second receptacle is accessible from outside, preferably from the rear, of the hand-guided battery-operated electric power tool (2) and is adapted to receive at least part of at least one further battery.

19. The hand-guided battery-operated electric power tool (2) according to claim 2, wherein the hand-guided battery-operated electric power tool (2) is designed as a polishing or sanding machine and the working element (20) is designed as a backing pad, wherein a bottom surface of the backing pad is adapted for releasable attachment of a polishing or sanding member (28), preferably by means of a hook-and-loop fastener.

20. The hand-guided battery-operated electric power tool (2) according to claim 2, wherein the axis of rotation (22) of the working element (20) extends substantially perpendicular to the longitudinal axis (36) of the hand-guided battery-operated electric power tool (2).

21. A hand-guided battery-operated electric power tool (2) designed as a polishing or sanding machine comprising
a tool housing (4) with a longitudinal extension along a longitudinal axis (36) of the hand-guided battery-operated electric power tool (2),
an electric motor (38) and at least one battery (40) for operating the electric motor (38), wherein the electric motor (38) and the at least one battery (40) are received in the tool housing (4),
a working element (20) designed as a backing pad, wherein a bottom surface of the backing pad is adapted for releasable attachment of a polishing or sanding member (28), which is rotatable about a first axis of rotation (22),
a tool shaft (34) which is rotatable about the first axis of rotation (22) and to which the working element (20) is directly or indirectly attached such that it protrudes from a front part (4.1) of the tool housing (4),
wherein the first axis of rotation (22) extends at an angle of >0° and <180° in respect to the longitudinal axis (36) of the hand-guided battery-operated electric power tool (2), and
wherein the tool housing (4) comprises along its longitudinal extension the front part (4.1) into which the first axis of rotation (22) extends, a rear part (4.3) opposite to the front part (4.1), and also comprises a centre part (4.2) between the front part (4.1) and the rear part (4.3),
wherein
the electric motor (38) is located in the front part (4.1) of the tool housing (4) and the at least one battery (40) is located in the centre part (4.2) of the tool housing (4), and in that
a motor shaft of the electric motor (38) is directly connected in a torque-proof manner to the tool shaft (34) of the hand-guided battery-operated electric power tool (2) or constitutes the tool shaft (34), or alternatively
the motor shaft of the electric motor (38) is indirectly connected to the tool shaft (34) of the hand-guided battery-operated electric power tool (2) by means of a transmission mechanism,
wherein in both cases the motor shaft of the electric motor (38) is rotatable about the first axis of rotation (22).
